(19) United States
(12) Patent Application Publication
(10) Pub. No.: US 2006/0266019 A1
(43) Pub. Date: Nov. 30, 2006

(54) Low-pressure EGR system and method

(76) Inventor: Laura M. Ricart-Ugaz, Chicago, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 11/140,015

(22) Filed: May 26, 2005

(51) Int. Cl. F02M 25/06; F01N 3/00

(52) U.S. Cl. 60/278; 60/297

(57) ABSTRACT

A turbocharged engine (301) with a turbine (305) having an outlet (306) and a compressor (307) having an inlet (308). An exhaust gas treatment module (317) is disposed in fluid communication with the outlet (306) of the turbine (305) and the inlet (308) of the compressor (307). The exhaust gas treatment module (317) may be advantageously mounted on the base engine (301), and disposed between an exhaust aftertreatment system (316) having an outlet to atmosphere, and the turbine outlet (306).

A method of operating the turbocharged engine (301) includes the steps of collecting exhaust gas, passing the exhaust gas though the turbine (305), and deciding whether to command exhaust gas recirculation (EGR). When EGR is not commanded, an EGR valve (311) is closed, and exhaust gas is passed from the turbine (305) through an exhaust aftertreatment module (316) and a muffler 133. When EGR is commanded, the EGR (311) valve is opened, and some exhaust gas is passed from the turbine (305) through a secondary exhaust treatment module (317) and compressor (307).

### FIELD OF THE INVENTION

This invention relates to emission controls for internal combustion engines, including but not limited to, low-pressure Exhaust Gas Recirculation (EGR) systems therefor.

### BACKGROUND OF THE INVENTION

Piston-driven internal combustion engines typically employ EGR systems for emission control. An EGR system entails the recirculation of combustion gases from the exhaust into the intake of the engine to reduce emission levels of the engine. The recirculated exhaust gas is typically cooled on turbocharged diesel engines during recirculation.

The implementation of an EGR system may change depending on the engine application. As allowable emission standards change, the industry is challenged with implementation of solutions for improving engine performance while still keeping emissions and component costs low.

Modern engines may employ either a high-pressure or a low-pressure EGR system. A high-pressure EGR system recirculates exhaust gas at a high-pressure, such as gas upstream of a turbocharger turbine, and deposits it back into a slightly lower but still high-pressure location, such as downstream of the turbocharger compressor. High-pressure EGR systems have many advantages but a main disadvantage is the limitation on the amount of exhaust gas that can be recirculated, as dictated by the difference in pressure between the exhaust and the intake systems of the engine. One method used in diesel engines, in part to address the issue of exhaust gas flow capability, is the implementation of a low-pressure EGR system.

A low pressure EGR system recirculates exhaust gas at a low pressure, such as gas downstream of the turbocharger turbine, and deposits it back into a low pressure location, such as upstream of the turbocharger compressor. A disadvantage of low-pressure EGR systems is the condensation of hydrocarbons on engine components. An additional disadvantage of low-pressure EGR systems is the placement of various components, especially if an EGR cooler is employed. Low-pressure EGR system components have been attached to the chassis of a vehicle. Attaching components on the chassis of the vehicle, as opposed to attaching these components on the engine, presents challenges in addressing component cost, reliability and practicality.

Accordingly, there is a need for an EGR system capable of delivering the performance of a low-pressure system that addresses the present issues of cost, reliability and practicality.

### SUMMARY OF THE INVENTION

An apparatus includes a base engine structure having an engine-mounted turbocharger with a turbine having an outlet, and a compressor having an inlet. An exhaust gas treatment module is also mounted on the base engine and is in fluid communication with the outlet of the turbine and the inlet of the compressor.

An apparatus includes a base engine structure having an engine-mounted turbocharger with a turbine having an outlet, and a compressor having an inlet. A chassis-mounted primary exhaust gas treatment module is operatively connected in fluid communication with the outlet of the turbine and a muffler. A secondary exhaust treatment module is provided in fluid communication with the outlet of the turbine upstream of the primary exhaust gas treatment module in fluid communication with the inlet of the compressor, preferably through an EGR control valve disposed between the turbine outlet and the compressor inlet.

A method of operating a turbocharged engine comprises the steps of collecting exhaust gas, passing the exhaust gas through a turbocharger turbine, and deciding whether to command exhaust gas recirculation (EGR). When EGR is not commanded, an EGR valve is closed, and exhaust gas is passed from the turbine through a primary exhaust treatment module and a muffler. When EGR is commanded, the EGR valve is opened, and exhaust gas is passed from the turbine through a secondary exhaust treatment module, and to a turbocharger compressor.

### BRIEF DESCRIPTION OF THE DRAWINGS

FIG. 1 is a block diagram of a typical high-pressure EGR system installed on a vehicle-chassis-mounted engine.

FIG. 2 is a block diagram of a typical low-pressure EGR system installed on a vehicle-chassis.

FIG. 3 is a block diagram of a low-pressure EGR system installed on an engine in accordance with the invention.

FIG. 4 is a block diagram of a low-pressure EGR system in accordance with the invention.

FIG. 5 is a flow chart for a method for a low-pressure EGR system in accordance with the invention.

### DETAILED DESCRIPTION

The following describes an apparatus for and a method of using a low-pressure EGR system mounted on an engine. Hydrocarbons present in recirculated exhaust gas condense under conditions of low temperature and pressure, and deposit on various engine components. Low-pressure EGR systems are prone to this condensation of hydrocarbons, which lowers the performance and efficiency of the EGR system. An additional disadvantage of low-pressure EGR systems is the location of the various system components, especially if an EGR cooler is employed, which are typically mounted on the vehicle for reasons to be discussed below. Mounting engine components on the vehicle, as opposed to mounting them directly on the engine, presents challenges in addressing component cost, reliability, and practicality. This invention addresses these issues by combining the advantages of mounting the EGR components directly on the engine, while still maintaining the advantages of using a low-pressure system.

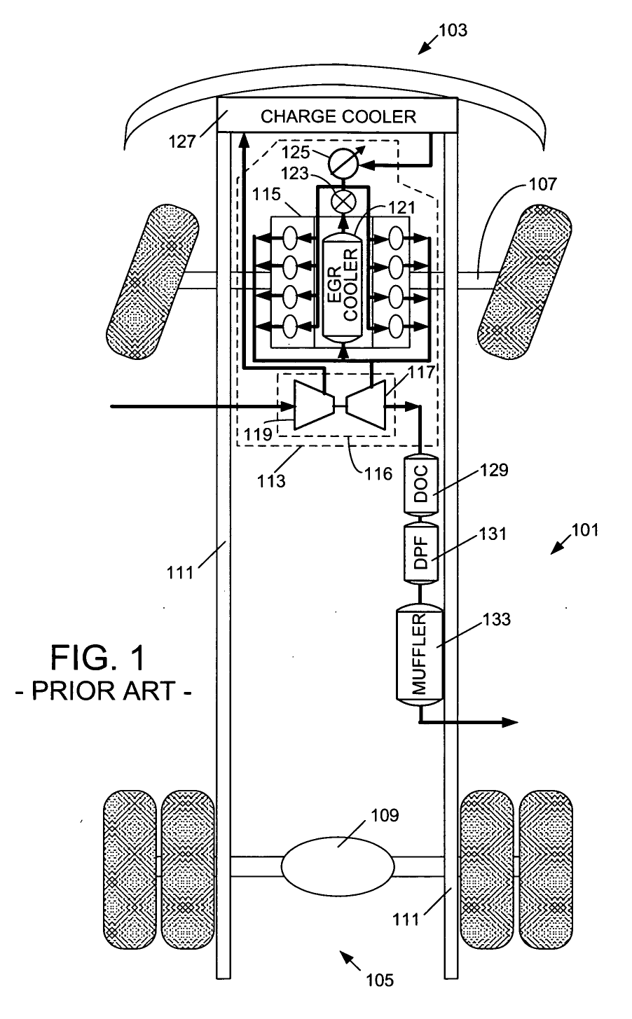

A block diagram for a typical known high-pressure EGR system is presented in FIG. 1. This representation shows a typical truck chassis 101 for illustration of the mounting scheme for various components. The chassis 101 has a front end 103 and a rear end 105. A front axle assembly 107 and a rear axle assembly 109 are shown. Two frame rails 111 arranged parallel to each other complete the chassis 101 for the purpose of this illustration. Typical truck chassis may include additional components. In the front of the chassis 101, an engine 113 is shown installed. The engine 113 has a set of eight cylinders 115, shown in a “V” configuration, a turbocharger 116 mounted on the engine 113 and including a turbine 117 operably connected to the cylinders to receive exhaust gas, and a compressor 119 driven by the turbine 117 and operably connected to deliver compressed air to the engine cylinders 115. An EGR cooler 121, an EGR valve 123, and an intake throttle 125 are also attached to the engine 113. Mounted on the front end 103 of the chassis 101 is a charge-air cooler 127. Exhaust aftertreatment components, that typically may include a catalytic converter, such as a Diesel Oxidation Catalyst (DOC) 129, a Diesel Particulate Filter (DPF) 131, and a muffler 133, are shown attached in series to the frame rail 111 rearward of the engine 113 to treat and release exhaust gas to the atmosphere.

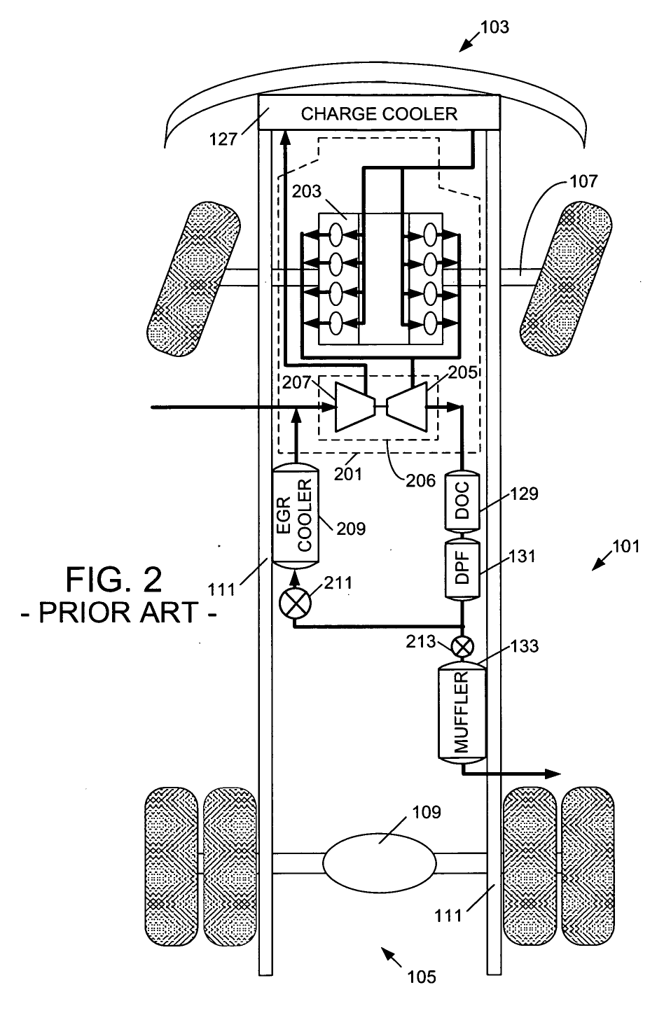

A typical known low-pressure EGR system is shown schematically in FIG. 2. This representation also shows the truck chassis 101 for illustration of the mounting scheme for various components. The engine 201 has a set of cylinders 203 (shown in a V8 configuration), a turbocharger 206 mounted on the engine 201 having a turbine 205 operably connected to receive exhaust gas from the cylinders 203, a compressor 207 driven by the turbine 205 and operably connected to deliver compressed air to the engine cylinders 203. An EGR cooler 209, and an EGR valve 123, are mounted on the frame rail 111. Mounted on the front end 103 of the chassis 101 is the Charge Cooler 127. Mounted on the frame rail 111 are after-treatment components that typically include a catalytic converter, such as a Diesel Oxidation Catalyst (DOC) 129, a Diesel Particulate Filter (DPF), and a muffler 133. A restrictor valve 213 may be present upstream of the muffler 133 to promote EGR gas flow.

As demonstrated by the systems presented in FIG. 1 and FIG. 2, the DOC 129, the DPF 131 and the muffler 133 are mounted on the chassis 101. On the high-pressure EGR system of FIG. 1, the EGR cooler 121 and EGR valve 123 are mounted on the engine 113. On the low-pressure EGR system of FIG. 2, the DOC 129, the DPF 131, and the muffler 133 are mounted on the chassis 101; the EGR cooler 209 and EGR valve 211 are not mounted on the engine 201, but are mounted on the chassis 101 to be in proximity to a treated exhaust gas supply before the muffler 133. The treated exhaust gas supply on a low-pressure EGR system is typically downstream of the aftertreatment components, for this illustration the DOC 129 and the DPF 131, and upstream of the muffler 133. This location ensures a lower concentration of hydrocarbon compounds to reduce the undesired effects of hydrocarbons condensing in the engine. As is shown in FIG. 2, pipes carrying exhaust gas to and from the EGR cooler 209 and EGR valve 211 are required to connect the inlet of the muffler 133 to the inlet of the compressor 207, traversing almost the entire length of the chassis 101. These pipes are exposed to road debris and are prone to damage, leakage from cracks forming due to chassis distortion during use, and corrosion from road salt.

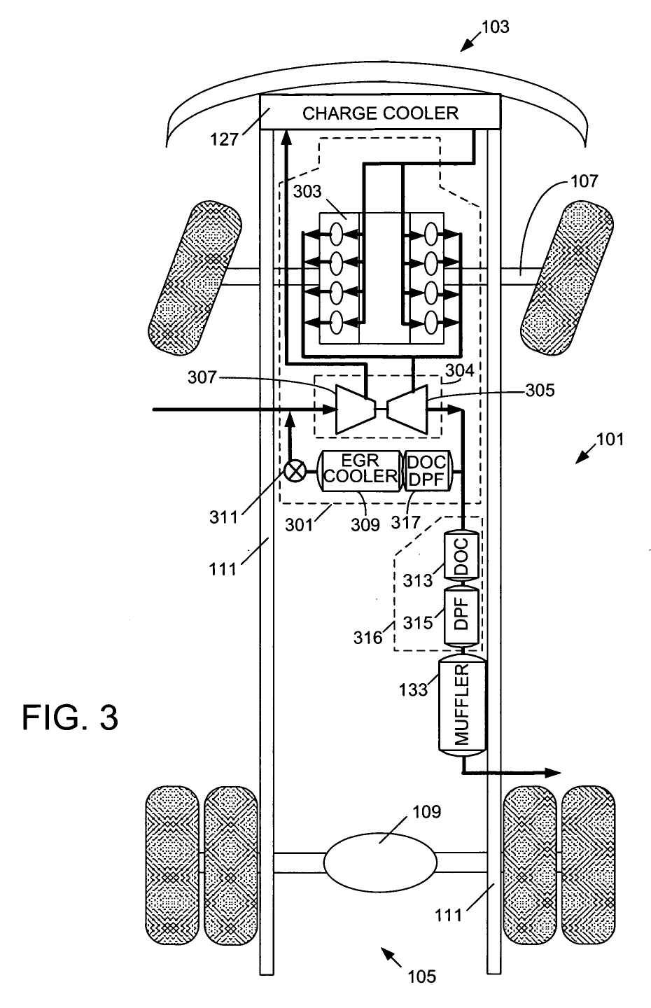

An embodiment for an engine-mounted low-pressure EGR system is presented in FIG. 3. This embodiment shows the truck chassis 101 for illustration of the mounting scheme for various components. An engine 301 has a set of eight cylinders 303 shown in a “V” configuration. A turbocharger 304 is mounted on the engine 301 and includes a turbine 305 operably connected to receive exhaust gas from the cylinders 303, and a compressor 307 driven by the turbine 305 and operably connected to deliver compressed air to the engine cylinders 303. An EGR cooler 309, and an EGR valve 311, are mounted to the rear portion of the engine 301. Mounted on the front end 103 of the chassis 101 is the Charge Cooler 127 that is operably connected between the compressor 307 and the cylinders 303. Mounted on the frame rail 111 rearward of the engine 301 are the muffler 133, and an aftertreatment module 316 containing, for example, a Diesel Oxidation Catalyst (DOC) 313 and a Diesel Particulate Filter (DPF) 315. An exhaust gas treatment module 317, containing, for example, a secondary DPF 403 and DOC 401, is mounted to the engine 301 adjacent to and upstream of the EGR cooler 309. The module 317 is similar in function to the aftertreatment module 316, but is advantageously smaller in size and capacity because it is expected to flow and process only the amount of exhaust gas being recirculated.

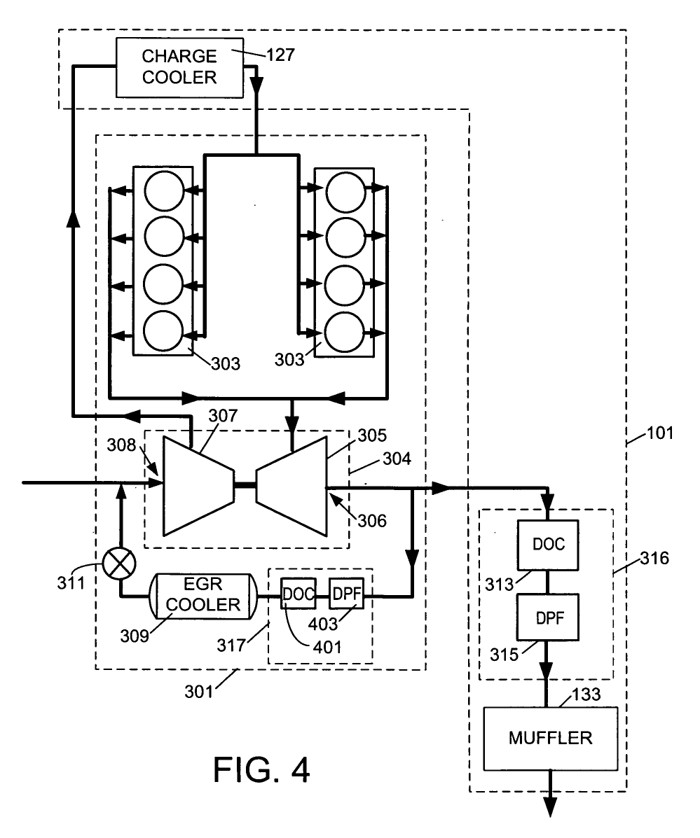

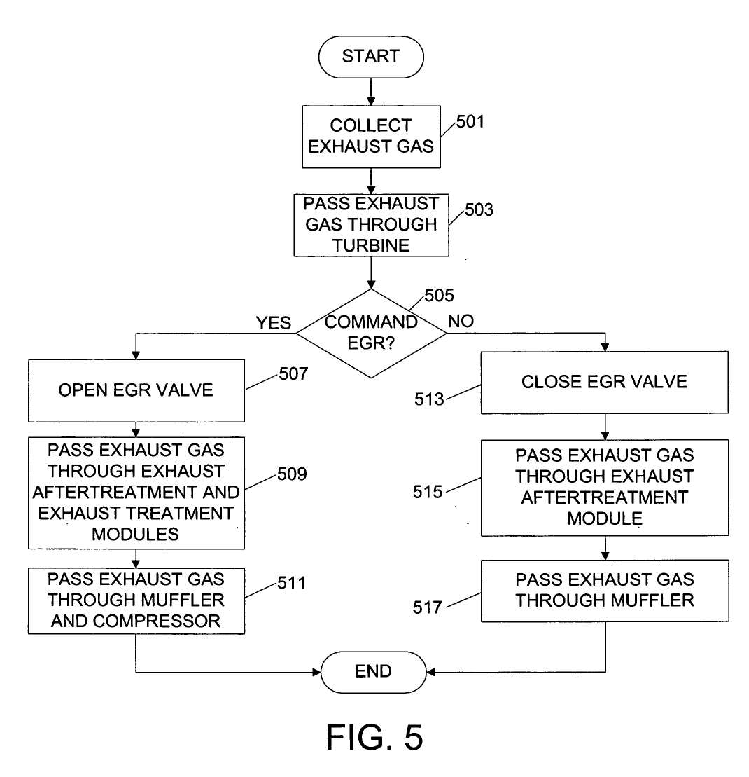

A schematic representation of the engine-mounted low-pressure EGR system is shown in FIG. 4, and a method is shown in FIG. 5. The engine 301 includes a set of cylinders 303. Attached to the engine 301 are the turbocharger 304 including the turbine 305 and the compressor 307, the exhaust gas treatment module 317 that includes a DPF element 403 and a DOC element 401, the EGR cooler 309, and the EGR valve 311. Exhaust gas from the engine 301 is collected in an exhaust manifold (not shown) in step 501 and routed to the turbine 305 in step 503. An engine Electronic Control Module (ECM) (not shown) monitors engine operation and makes a decision to command EGR in step 505 based on various operating parameters of the engine. The EGR valve 311 is opened in step 507 causing exhaust gas to flow from an outlet 306 of the turbine 305, through the module 317 in step 509, the EGR cooler 309, the EGR valve 311, and into an inlet 308 of the compressor 307. Exhaust gas that is not recirculated flows through the aftertreatment module 316 and the muffler 133 in step 511. The flow of exhaust gas through the aftertreatment module 316 can be advantageously restricted at times, for example by a valve (not shown), to increase flow through the exhaust gas treatment module 317. If the decision is made not to command EGR in step 505, the EGR valve 311 is closed in step 513, exhaust gas from the outlet 306 of the turbine 305 flows substantially through the aftertreatment module 316 in step 515, and eventually flows through the muffler 133 in step 517. When EGR is not commanded, the intent is for the majority, or more than 90%, of exhaust gas from the engine to be expelled to the environment.

The embodiment of FIG. 3 through FIG. 5 is advantageous in various respects. First, this embodiment allows the attachment of more components directly on the engine, rather than mounting them on the chassis, thereby avoiding the added cost, complexity, and reliability risk associated with typical configurations of low-pressure EGR systems. Second, the proximity of the exhaust gas treatment module 317 to the exit of the turbine 305 advantageously provides exhaust gas at a higher pressure and temperature than a typical low-pressure EGR system. Higher exhaust gas pressure and temperature help reduce hydrocarbon condensation in the engine, help regenerate the DPF 403, and help improve the flow capability of the EGR system. Third, commonality of engine components may reduce development costs. Engines using high-pressure EGR systems that typically have their EGR system components installed on-engine can easily be converted to engines using low-pressure EGR systems, by mounting the low-pressure EGR system components on the engine to replace the high-pressure EGR system components.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An engine comprising:
a plurality of cylinders;
a turbocharger mounted on the engine, the turbocharger including a turbine having an outlet and a compressor having an inlet, the turbine and the compressor operably fluidly connected to the plurality of cylinders;
an exhaust gas treatment module operably connected in fluid communication with the outlet of the turbine and the inlet of the compressor;
wherein the exhaust gas treatment module is mounted on the engine.

2. The apparatus of claim 1, further comprising an exhaust gas cooler in fluid communication with the exhaust gas treatment module.

3. The apparatus of claim 2, further comprising an exhaust gas control valve disposed in fluid communication with at least one of the inlet and an outlet of the exhaust gas cooler.

4. The apparatus of claim 3, wherein the exhaust gas control valve is mounted on the engine.

5. The apparatus of claim 1, wherein the exhaust gas treatment module comprises at least one of a first particulate filter and a first catalytic converter.

6. The apparatus of claim 1, further comprising a vehicle chassis operably connected to the base engine.

7. The apparatus of claim 6, further comprising a second particulate filter, a second catalytic converter, and a muffler, operably connected to the chassis, and in fluid communication with the outlet of the turbine downstream of the exhaust gas treatment module.

8. The apparatus of claim 6, further comprising a charge cooler, operably connected to the chassis, and in fluid communication with an outlet of the compressor.

9. A method comprising the steps of:
collecting exhaust gas from an engine having cylinders;
passing the exhaust gas through a turbine of a turbocharger;
deciding on a command for exhaust gas recirculation (EGR) from the turbocharger turbine to said cylinders;
when EGR is not commanded,
closing an EGR valve,
passing exhaust gas through an exhaust aftertreatment module,
passing exhaust gas through a muffler; and
when EGR is commanded,
opening the EGR valve,
passing exhaust gas through an exhaust treatment module, and
passing exhaust gas through a compressor to the plurality of cylinders.

10. The method of claim 9, wherein exhaust gas is substantially blocked from passing through the exhaust treatment module and the compressor when EGR is not commanded.

11. The method of claim 9, wherein the decision is made in an electronic control module based on operating parameters of the engine.

12. The method of claim 9, further comprising the step of restricting exhaust gas flow at an inlet to the muffler.

13. An internal combustion engine comprising:
a base engine structure having cylinders in fluid communication with an intake manifold and an exhaust manifold;
a turbocharger mounted on the engine structure comprising a turbine having a turbine inlet in fluid communication with the exhaust manifold, and a turbine outlet in fluid communication with an exhaust aftertreatment system, the exhaust aftertreatment system having an outlet to the atmosphere, wherein the turbocharger further comprises a compressor having a compressor inlet, and a compressor outlet in fluid communication with the intake manifold; and
an exhaust gas cooling and treatment apparatus comprising:
an exhaust gas cooler,
an exhaust gas valve in fluid communication with the cooler, and
at least one of an exhaust gas particulate filter and a converter, in fluid communication with the valve;
wherein the exhaust gas cooling and treatment apparatus is fluidly connected between the turbine outlet and the compressor inlet.

14. The internal combustion engine of claim 13, wherein the exhaust gas cooling and treatment apparatus is disposed on the base engine structure.

15. The internal combustion engine of claim 13, wherein the exhaust gas cooling and treatment apparatus is disposed upstream of the exhaust gas cooler and the exhaust gas valve.

16. The internal combustion engine of claim 13, further comprising a restrictor valve in fluid communication with the exhaust after-treatment module.

17. The internal combustion engine of claim 13, further comprising an Electronic Control Module electrically connected to the exhaust gas valve.

18. The internal combustion engine of claim 13, further comprising a muffler in fluid communication with the turbine outlet.

19. The internal combustion engine of claim 13, further comprising a charge cooler in fluid communication with the compressor inlet.

20. The internal combustion engine of claim 13, wherein the exhaust gas valve is disposed downstream of the exhaust gas cooler.
